(19) United States
(12) Patent Application Publication
(10) Pub. No.: US 2015/0348434 A1
(43) Pub. Date: Dec. 3, 2015

(54) METHOD FOR TEACHING HIGH FREQUENCY WORD RECOGNITION

(71) Applicant: Cynthia H. Carcia Kelly, Amston, CT (US)

(72) Inventor: Cynthia H. Carcia Kelly, Amston, CT (US)

(21) Appl. No.: 14/293,597

(22) Filed: Jun. 2, 2014

(51) Int. Cl. G09B 19/00

(52) U.S. Cl. CPC G09B 19/00

(57) ABSTRACT

A method for teaching high frequency word recognition comprising the steps of selecting a first series of words for a small group of students, initiating a first round in a Follow the Teacher instructional procedure with the teacher reading each word in rapid succession with each student simultaneously viewing each word and reading it immediately after the teacher, repeating the reading of words in the group at the fastest possible speed with the teacher leading and carefully observing the students and their eye movements to make certain that they are in fact looking directly at the words and not really following the sound of the teacher's voice or that of the group, repeating the procedure until the teacher is satisfied that each student has made significant progress and has attained a high level of visual retention for the words as well as an instant sight recognition of the words or has an improved ability to rapidly name words after the teacher.

### BACKGROUND OF THE INVENTION

Various word recognition teaching methods are available in the prior art. None of the methods found, however, is wholly satisfactory.

It is the general object of the present invention to provide a rapid-fire instructional method that results in strengthening underlying processes supporting an exceptionally high rate of word recognition and retention and enhanced self-efficacy and motivation of the student.

### SUMMARY OF THE INVENTION

### Follow the Teacher

In fulfillment of the foregoing object and in accordance with the present invention, a method known as “Mastery in Minutes” for teaching high frequency word recognition is provided and comprises the steps of selecting a first series of words (preferably six (6) or nine (9) words in two rows of three (3) each) for a small group of students (preferably one (1) to three (3)). Each session of “Mastery in Minutes” lasts for approximately fifteen minutes and consists of four instructional activities to be completed consecutively in one session with one set of either six or nine words. A first round in a “Follow the Teacher,” rapid-fire instructional procedure is initiated with the teacher reading each word rapidly in succession and in the order that one would read a paragraph with each student simultaneously viewing each word and reading it immediately after the teacher. Repeating the words in the group at the fastest possible speed with the teacher leading and carefully observing the students and their eye movements to make certain that each student is in fact looking directly at the words and not merely following the sound of the teacher's voice or that of the group. Again repeating the foregoing procedure until the teacher is satisfied that each student has made significant progress in learning to sight read the majority of words in the set and has improved their level of visual retention for the majority of words as well as instant recognition for most of the words. All of the foregoing obviously contributes to the enhanced self-efficacy and motivation of the student.

As student progress is noted in future sessions of “Mastery in Minutes,” the set of words instructed in one session is increased to nine, and a modified procedure may also be introduced whereby the student initially points at each word as he or she reads the word.

### Word Hunt

In this aspect of the method, the teacher calls out a word at random instructing the students to search for the word, point to the word, and read it aloud. The students are also instructed to search for the word with their eyes only and to employ a pointer finger to indicate the word quickly and directly without blocking the view of others. Once a word is read, the pointer finger immediately returns back to start position. The teacher then proceeds to increase the frequency of the words called out to the extent possible without sacrificing accuracy. The teacher should simultaneously impress the students with a win-win attitude emphasizing that each student should do his/her best and that it is not important who points and reads first.

### Lightning Strike

The “Lightning Strike” activity is similar to and a derivative of the “Word Hunt” activity, with each word being printed on an individual flash card and with the teacher calling out words randomly and as rapidly as possible. The students locate read, call out, and remove cards individually and as quickly and accurately as possible. When all cards have been removed, the students commence reading, calling out, and returning the cards in the same original overall configuration but in a new random order. As student fluidity in reading and moving word cards increases, further rounds may then be initiated wherein the teacher competes with each student, with the teacher calling out a word, waiting until student locates the called word with his/her eyes, and then attempting to pick up the card bearing the word before the student can reach it. The teacher should strive to slap down on the card either simultaneously or a split second after the student to insure student success the majority of the time.

### Word Race

The “Word Race” is introduced with the teacher gathering all cards in a pile and holding them up in front of the students sequentially with the students reading the words in succession for a total of ten rounds. As students demonstrate ability to rapidly read words, the word order is randomly mixed for each round by the teacher. Students are challenged to read the words as accurately and rapidly as possible.

### DESCRIPTION OF THE DRAWINGS

FIG. 1 is a schematic illustration showing six (6) high frequency words printed on individual cards and arranged in rows of three each,

FIG. 2 is a schematic illustration showing nine (9) high frequency words printed on individual cards and arranged in rows of three each.

### DESCRIPTION OF PREFERRED EMBODIMENT

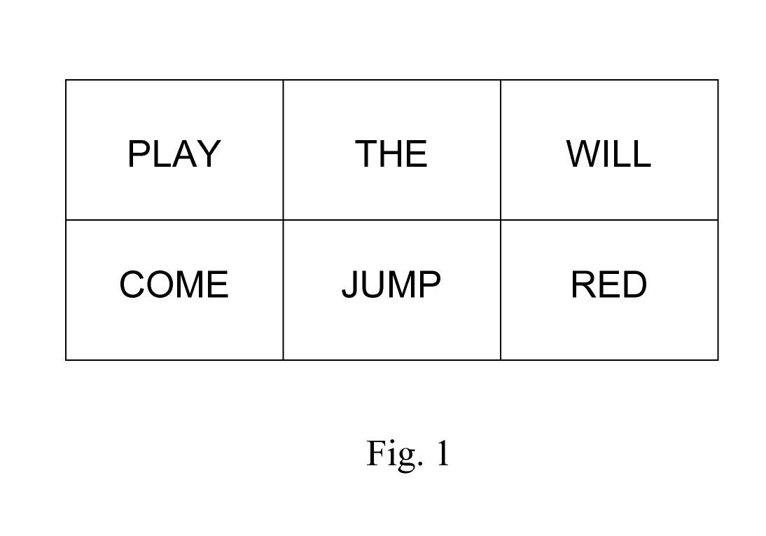

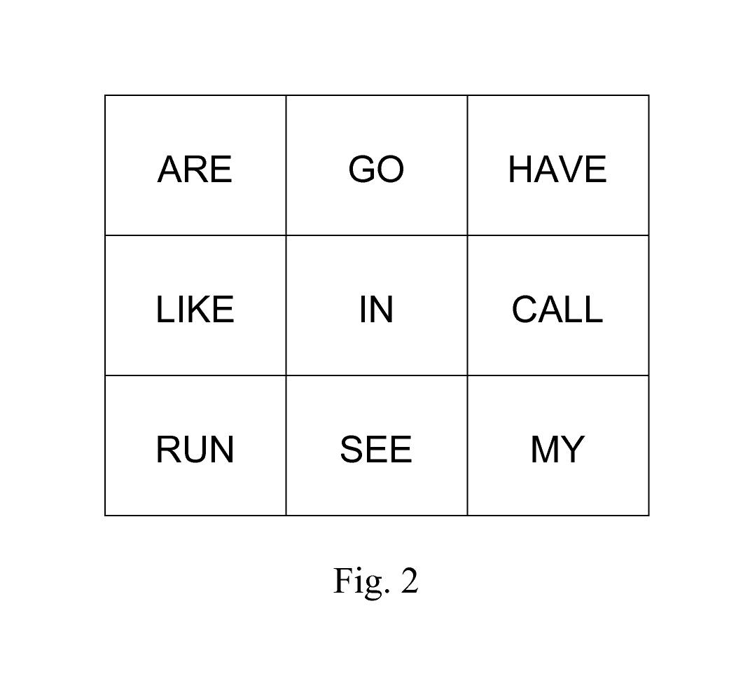

Referring to FIG. 1, six (6) individual flash cards 10-20 are shown with the words “PLAY,” “THE,” “WILL,” “COME,” “JUMP,” AND “RED” printed thereon respectively. In FIG. 2, nine individual cards are shown at 22-30 with the words “ARE,” “GO,” “HAVE,” “LIKE,” “IN,” “CALL,” “RUN,” “SEE,” AND “MY” printed thereon respectively.

The foregoing “Mastery in Minutes” method as set forth in the SUMMARY OF INVENTION should always be practiced in the light of the following:

### Follow the Teacher

“Follow the Teacher” should be introduced to the students with the teacher explaining that he/she will point to and read each word in sequence. In Round 1, the teacher should begin with a slow, steady pace and then move to a rapid, exhilarating pace while still maintaining word accuracy employing the method set forth above. The teacher should keep in mind that the students will react at varying rates and student groupings may need to be adjusted to allow for different learning rates.

The teacher follows a specific instructional procedure for choosing words to instruct. The teacher creates a word bank by writing words on cards utilizing high frequency word list assessment data with one word per card. Words are held up one at a time. If the student does not read the word within three seconds, it is considered for instruction. However, the teacher must first check that visually similar words, words that begin with vowel sounds, words that lack “stand alone” meaning and words that students consistently confuse are not instructed together in the same set of words. The majority of children will not require the above tactics, but the children who have specific learning weaknesses should experience the same immediate sense of success as other children. Therefore, the procedure must be followed to insure success.

Ongoing assessment is embedded in the process to insure that words are retained over time. After the initial “Mastery in Minutes” session is complete, further instructional sessions begin by assessing word retention from previous sessions and if a student cannot read previously instructed word within approximately three seconds, the word is reinstructed in another session of “Mastery in Minutes.” New words are introduced as space in the six or nine word configuration is available. The maximum number of students in each group should remain at three.

Each student should reach a level of proficiency wherein he/she can read each word within three seconds.

To help each student build self-efficacy, the teacher should explicitly delineate a connection between doing his/her best work, practice, and success. Employ the analogy of exercising one's body to become stronger and exercising one's brain to become smarter as well as to learn faster and better. The student should be advised that new words are to be learned and are not words that he/she is expected to know immediately. In building self-efficacy, the student should be told that he/she is learning to read the words so fast because of how well he/she is focused, that being determined helps to learn and read words faster, that his/her brain is gaining strength in its ability to read new words and when all of the words are learned, the student will feel proud having done his/her best work and succeeding in learning to read new words.

### Objectives

1. Students will learn to read high frequency words at an accelerated rate of speed.
2. Students will strengthen their visual memory and/or rapid naming skills in general, and this will enable them to read more words by sight in increasingly shorter time frames and retain them over time.
3. Students will be able to read sight words in context with improved fluency and speed.
4. Students will experience an immediate sense of success in reading thus enhancing their self-efficacy and motivation.
5. Students will experience a sense of fun, excitement, and joy while learning to read new words.
6. Students will be able to read content area and guided reading vocabulary when method is employed with these words.
7. With consistent Mastery in Minutes sessions and fidelity to the rules, students' ability to remember reading words encountered when reading text will strengthen.

### Word Hunt

In practicing the “Word Hunt” activity the students should be instructed to keep their hands still while searching for a called word with their eyes only. When the student finds the word he/she should use his/her pointer finger to indicate the word without blocking the view of others. The teacher should explain to the students that it is not important who points to each word first but rather that each student points to and reads each word as quickly as he/she can. The teacher should emphasize a team approach telling the students that everyone will learn faster by working together.

The students should be instructed to guard against “helicopter hands” rather than a pointer finger that impede the view of others. Words should be read at a rapid pace slowing down only to insure accuracy and student confidence. Words should be kept on the table in the same order as in “Follow the Teacher” for the entire “Word Hunt” activity.

### Lightning Strike

The goal of “Lightning Strike” is to locate, read and remove words from the table as rapidly as possible. The teacher continues to call out words at random setting the fastest pace possible while maintaining student accuracy. The student searches for the word keeping his/her hands still. Once the student locates the word he/she calls out the word and removes the corresponding card from the table as quickly as possible. All students in the group are responsible for searching for all of the called words with their eyes, but students alternate, round robin style, calling out and removing cards from the table. When all cards have been removed from the table the students commence returning the cards to the table in random order reading the words on the cards as each card is returned. The teacher then initiates further rounds by calling out words at random.

As further rounds progress, the teacher increases the rate of call-out to determine the students challenge level and then reduce the rate only enough to insure accuracy. Once again, the teacher should make certain that each student is successful. This part of the method should be exhilarating, motivating and fun. Laughter is always a part of “Lightning Strike.”

### Word Race

The teacher should tell the students that they are going to have a “Word Race” as a finale and then collect all word cards, and hold them in front of the students. The teacher then flips through the cards as fast as the students can read them. As in “Lightning Strike,” above, all students are instructed to read all of the words orally when it is their turn and silently when it is not their turn. The phrase “every turn is your turn” is used to reinforce the concept of one hundred percent participation for all students. In addition to using the round robin style delineated in “Lightning Strike,” the teacher can have individual students take a turn reading through the entire set orally while the other students read silently. This process continues for ten rounds. When the ten rounds are complete, the teacher ends the session by strengthening self-efficacy, constructive work habits and intrinsic motivation. This is accomplished by making comments explicitly linking being determined, following directions, and doing best work with the student's success at reading new words, and the ability to strengthen their mind's ability in this regard.

### CONCLUSION

In conclusion it can be said that the practice of the “Mastery in Minutes” method effectively improves word retention at a high rate of speed, strengthens the processes underlying word recognition, builds the students' self-efficacy, intrinsic motivation, and determination and encourages good work habits and the ability to follow directions.

1. A method for teaching high frequency word recognition comprising the steps of selecting a first series of words for a small group of students, initiating a first round in a Follow the Teacher instructional procedure with the teacher reading each word in rapid succession in the order that one would read a paragraph and with each student simultaneously viewing each word and reading it immediately after the teacher, repeating the reading of the words in the group at the fastest possible speed with the teacher leading and carefully observing the students and their eye movements to make certain that they are in fact looking directly at the words and not merely following the sound of the teacher's voice or that of the group, repeating the procedure until the teacher is satisfied that each student has made significant progress in learning to sight read the majority of words being instructed and has attained a high level of visual retention for the words as well as an instant sight recognition of the words or has improved in ability to rapidly name words after the teacher.

2. A method for teaching high frequency word recognition as set forth in claim 1 wherein the first series of words takes the form of six words arranged in two rows of three each.

3. A method for teaching high frequency word recognition as set forth in claim 1 wherein the first series of words takes the form of nine words arranged in three rows of three each.

4. A method for teaching high frequency word recognition as set forth in claim 1 wherein one (1) to three (3) students are provided in a small group.

5. A method for teaching high frequency word recognition as set forth in claim 1 wherein each student initially points at each word as he/she reads the word.

6. A method for teaching high frequency word recognition comprising the steps of selecting a first group of words for a small group of students, initiating a Word Hunt activity by having a teacher call out a word at random, instructing the students to search for the word, point to it and read it aloud, the students also being instructed to search for the word with eyes only and employ a pointer finger to indicate the word quickly and directly without impeding the view of others, increasing the frequency of the words called out by the teacher to the extent possible without losing accuracy, impressing the students with a win-win attitude emphasizing that each student do his/her best and that it is not important who points and reads first.

7. A method for teaching high frequency word recognition as set forth in claim 6 wherein the first series of words takes the form of six words arranged in two rows of three each.

8. A method for teaching high frequency word recognition as set forth in claim 6 wherein the first series of words takes the form of nine words arranged in three rows of three each.

9. A method for teaching high frequency word recognition as set forth in claim 6 wherein one (1) to three (3) students are provided in a small group.

10. A method for teaching high frequency word recognition as set forth in claim 6 wherein the Word Hunt activity is converted to an activity called “Lightning Strike” with each word printed on an individual card and with the teacher continuing to call out words randomly and as rapidly as possible, and with the students locating, reading, calling out and removing cards individually as quickly and accurately as possible, when all cards have been removed students commence reading, calling out and returning the cards in the same original overall configuration but in random order, initiating several rounds and finally initiating several rounds wherein the teacher competes with each student with the teacher calling out a word, waiting for the student to find the word with his/her eyes and then attempting to pick up a card before the student can reach it, the teacher always being careful to allow each student to succeed most of the time.

11. A method for teaching high frequency word recognition as set forth in claim 10 wherein the first series of words takes the form of six words arranged in two rows of three each.

12. A method for teaching high frequency word recognition as set forth in claim 10 wherein the first series of words takes the form of nine words arranged in three rows of three each.

13. A method for teaching high frequency word recognition as set forth in claim 1, 6, or 10 wherein on completion of the activity set forth in the claim a final activity called word race is introduced with the teacher gathering all cards into a pile and holding them up in front of the students sequentially with the students reading the words rapidly in succession for a total of ten rounds, during each round words being placed on the table in alternating order or shuffled at the end of each round so that succeeding rounds contain words in a new random order.
